(19) United States
(12) Patent Application Publication
(10) Pub. No.: US 2013/0290841 A1
(43) Pub. Date: Oct. 31, 2013

(54) NON-TRANSITORY COMPUTER READABLE MEDIUM, VIRTUAL-SHEET MANAGEMENT APPARATUS, AND VIRTUAL-SHEET MANAGEMENT METHOD

(71) Applicant: FUJI XEROX CO., LTD., Tokyo (JP)

(72) Inventors: Nobuyuki YAMAZOE, Yokohama-shi (JP); Yusuke KANO, Yokohama-shi (JP); Yuki NAKAMORI, Yokohama-shi (JP)

(73) Assignee: FUJI XEROX CO., LTD., Tokyo (JP)

(21) Appl. No.: 13/659,047

(22) Filed: Oct. 24, 2012

(30) Foreign Application Priority Data
Apr. 26, 2012 (JP) 2012-101589

(51) Int. Cl. G06F 17/00

(52) U.S. Cl. 715/273

(57) ABSTRACT

A non-transitory computer readable medium stores a program causing a computer to perform a process for virtual-sheet management. The process includes storing pieces of sticky note information, pieces of sheet information, first apparatus sheet information that specifies priority sheet information, and second apparatus sheet information that specifies target sheet information; displaying a virtual sheet of selected sheet information in each of first and second apparatuses; updating the first apparatus sheet information upon the priority sheet information being selected and updating the second apparatus sheet information upon the target sheet information being selected; and performing control to selectively display a first decoration, a second decoration, and a third decoration together with the virtual sheet in each of the first and second apparatuses in accordance with the first apparatus sheet information, the second apparatus sheet information, and the virtual sheet currently displayed in the first apparatus.

### CROSS-REFERENCE TO RELATED APPLICATIONS

This application is based on and claims priority under 35 USC 119 from Japanese Patent Application No. 2012-101589 filed Apr. 26, 2012.

### BACKGROUND

### Technical Field

The present invention relates to a non-transitory computer readable medium, a virtual-sheet management apparatus, and a virtual-sheet management method.

### SUMMARY

According to an aspect of the invention, there is provided a non-transitory computer readable medium storing a program causing a computer to execute a process for virtual-sheet management. The process includes storing, in a memory, plural pieces of sticky note information used to display plural virtual sticky notes in a first apparatus including a display viewed by plural users and in a second apparatus including a display smaller than the display of the first apparatus, plural pieces of sheet information each of which is used to display a virtual sheet as the background of plural virtual sticky notes in the first apparatus and the second apparatus, and each of which is to be associated with plural pieces of sticky note information corresponding to the plural virtual sticky notes displayed on the virtual sheet, first apparatus sheet information that specifies priority sheet information which is selected, as sheet information that is given priority, in the first apparatus from among the plural pieces of sheet information, and second apparatus sheet information that specifies target sheet information which is selected, as sheet information with which sticky note information is to be associated, in the second apparatus from among the plural pieces of sheet information; displaying on the display of the first apparatus, a virtual sheet of sheet information that is selected in the first apparatus from among the plural pieces of sheet information stored in the memory and that is to be associated with plural pieces of sticky note information, and on the display of the second apparatus, a virtual sheet of sheet information that is selected in the second apparatus from among the plural pieces of sheet information stored in the memory and that is to be associated with plural pieces of sticky note information; updating upon the priority sheet information being selected in the first apparatus, the first apparatus sheet information in accordance with the selected priority sheet information, and upon the target sheet information being selected in the second apparatus, the second apparatus sheet information in accordance with the selected target sheet information; and performing control if the sheet information of the virtual sheet that is being displayed in the first apparatus is selected as the priority sheet information specified by the first apparatus sheet information and association of sticky note information with the sheet information is to be accepted, so as to display a first decoration together with the virtual sheet of the sheet information in the first apparatus, if the sheet information of the virtual sheet that is being displayed in the first apparatus is not selected as the priority sheet information specified by the first apparatus sheet information but association of sticky note information with the sheet information is to be accepted, so as to display a second decoration together with the virtual sheet of the sheet information in the first apparatus, the second decoration being different from the first decoration, if the target sheet information specified by the second apparatus sheet information is selected as the priority sheet information and is of the virtual sheet that is being displayed in the first apparatus, so as to display the first decoration together with the virtual sheet of the target sheet information in the second apparatus, if the target sheet information specified by the second apparatus sheet information is not selected as the priority sheet information but is of the virtual sheet that is being displayed in the first apparatus or if the target sheet information specified by the second apparatus sheet information is selected as the priority sheet information but is not of the virtual sheet that is being displayed in the first apparatus, so as to display the second decoration together with the virtual sheet of the target sheet information in the second apparatus, the second decoration being different from the first decoration, and if the target sheet information specified by the second apparatus sheet information is not selected as the priority sheet information and is not of the virtual sheet that is being displayed in the first apparatus, so as to display a third decoration together with the virtual sheet of the target sheet information in the second apparatus, the third decoration being different from the first decoration and the second decoration.

### BRIEF DESCRIPTION OF THE DRAWINGS

Exemplary embodiments of the present invention will be described in detail based on the following figures, wherein:

FIG. 1 is a schematic view illustrating an example of the configuration of a sheet management system according to an exemplary embodiment of the present invention;

FIG. 2 is a block diagram illustrating an example of the configuration of a sheet management server;

FIG. 3 is a schematic view illustrating an example of the structure of terminal information;

FIG. 4 is a schematic view illustrating an example of the structure of sheet information;

FIG. 5 is a schematic view illustrating an example of the structure of electronic whiteboard sheet information;

FIG. 6 is a schematic view illustrating an example of the structure of information terminal sheet information;

FIGS. 7A and 7B are state diagrams for explaining an example of the operation of the sheet management server;

FIGS. 8A to 8G are schematic views for explaining examples of the operation of the sheet management server;

FIGS. 9A to 9D are schematic views for explaining examples of the operation of the sheet management server;

FIGS. 10A to 10C are schematic views for explaining examples of the operation of the sheet management server;

FIGS. 11A and 11B are schematic views for explaining examples of the operation of the sheet management server;

FIG. 12 is a flowchart for explaining examples of the operations of the sheet management server and the electronic whiteboard; and

FIG. 13 is a flowchart for explaining examples of the operations of the sheet management server and the information terminal.

### DETAILED DESCRIPTION

### Configuration of Sheet Management System

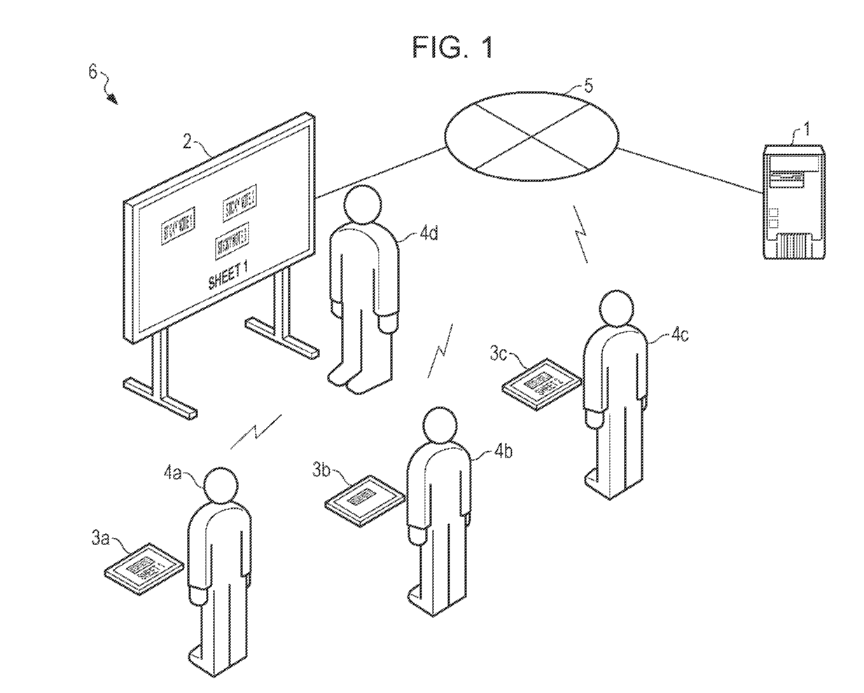

FIG. 1 is a schematic view illustrating an example of the configuration of a sheet management system according to an exemplary embodiment of the present invention.

A sheet management system 6 is used with conference techniques, such as one called brainstorming, and includes a sheet management server 1, an electronic whiteboard 2 serving as a first apparatus, and information terminals 3a to 3c each serving as a second apparatus. The sheet management server 1 attaches virtual sticky notes and the like to virtual sheets and manages the virtual sticky notes. The electronic whiteboard 2 displays images, such as virtual sticky notes and virtual sheets, in accordance with information managed by the sheet management server 1 and allows the user to operate the images. The sheet management server 1, the electronic whiteboard 2, and the information terminals 3a to 3c are connected via a network 5 to be able to perform communication.

The sheet management server 1 of the sheet management system 6 manages information regarding plural virtual sheets (hereinafter, each referred to as “sheet information”) using the above-described configuration. Once users 4a to 4d create virtual sticky notes by using the information terminals 3a to 3c and the electronic whiteboard 2, respectively, the sheet management server 1 receives information regarding the created virtual sticky notes (hereinafter, each referred to as “sticky note information”) and attaches the sticky notes to a sheet specified in advance. Sticky notes attached to a sheet may be displayed in any layout on the electronic whiteboard 2.

The electronic whiteboard 2 typically includes a large display screen and functions as the host. The information terminals 3a to 3c typically have smaller screens than the electronic whiteboard 2 and function as clients of the electronic whiteboard 2.

The information terminals 3a to 3c and the electronic whiteboard 2 are able to display each of the plural virtual sheets along with sticky notes attached to the displayed virtual sheet. The electronic whiteboard 2 is often operated by the conference moderator (brainstorming facilitator, for example, user 4d). The information terminals 3a to 3c are often operated by the conference participants (users 4a to 4c).

Herein, the operation “to attach” (or “to send”) a sticky note to a sheet indicates “to associate sticky note information with specified sheet information”. Non-sticky note information, such as document information and image information, may also be associated with sheet information.

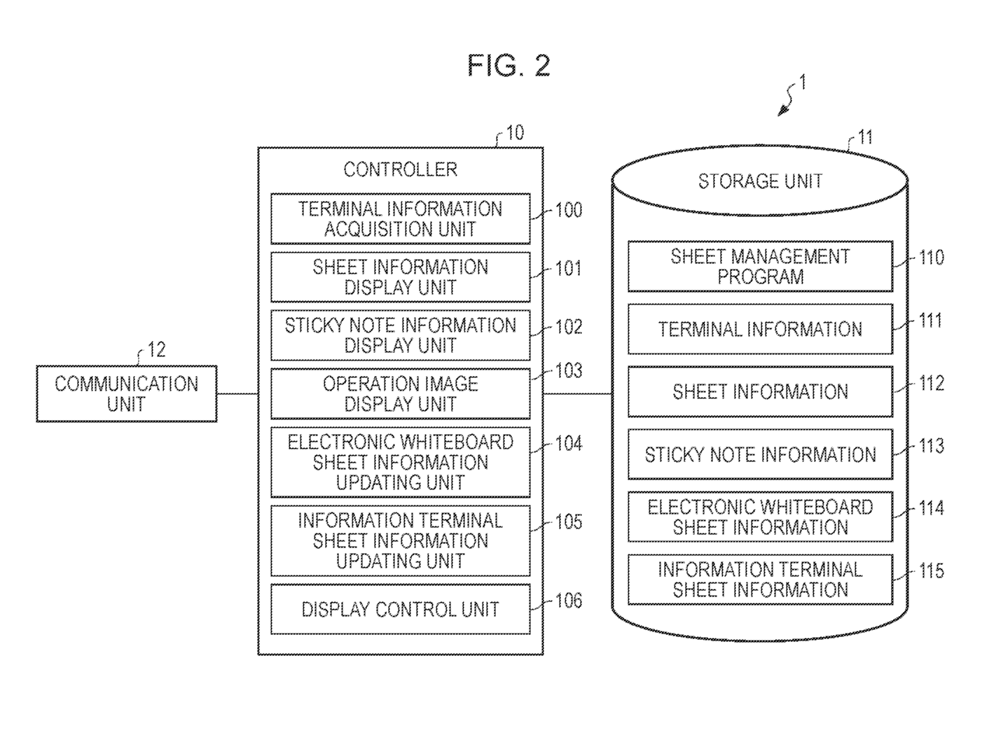

FIG. 2 is a block diagram illustrating an example of the configuration of the sheet management server 1 (virtual-sheet management apparatus).

The sheet management server 1 includes a controller 10, a storage unit 11, and a communication unit 12 that communicates with external apparatuses. The controller 10, which includes a central processing unit (CPU), executes various programs and controls each unit. The storage unit 11, which includes a hard disk drive (HDD) and a storage medium, such as a flash memory, stores information. The sheet management server 1 may be, for example, a computer, such as a server; or a portable device, such as a personal digital assistant (PDA) or mobile phone. The sheet management server 1 may further include a display, such as a liquid crystal display, for displaying text, figures, etc.; and an operation unit, which includes a keyboard and a mouse used for input operations.

The controller 10 executes a sheet management program 110 described below, thereby functioning as a terminal information acquisition unit 100, a sheet information display unit 101, a sticky note information display unit 102, an operation image display unit 103, an electronic whiteboard sheet information updating unit 104, an information terminal sheet information updating unit 105, and a display control unit 106. In addition to the above units 100 to 106, the controller 10 also functions as units for displaying, operating, and editing sheets and sticky notes.

The terminal information acquisition unit 100 acquires, from the storage unit 11, terminal information 111 for identifying individual terminals, such as, the electronic whiteboard 2 and the information terminals 3a to 3c.

The sheet information display unit 101 outputs sheet information 112 requested by each of the electronic whiteboard 2 and the information terminals 3a to 3c after converting the sheet information 112 into a format that is displayable by the requestor.

The sticky note information display unit 102 outputs sticky note information 113 requested by each of the electronic whiteboard 2 and the information terminals 3a to 3c after converting the sticky note information 113 into a format that is displayable by the requestor.

The operation image display unit 103 displays images of operation buttons, such as the sheet switching button and the enter button.

The electronic whiteboard sheet information updating unit 104 updates electronic whiteboard sheet information 114, which defines the state of a sheet displayed in the electronic whiteboard 2.

The information terminal sheet information updating unit 105 updates information terminal sheet information 115, which defines sheets that are being displayed in the information terminals 3a to 3c and sheets to which sticky notes are to be sent.

The display control unit 106 changes images displayed in the electronic whiteboard 2 in accordance with contents of the electronic whiteboard sheet information 114. The display control unit 106 also changes images displayed in the information terminals 3a to 3c in accordance with contents of the information terminal sheet information 115 and of the electronic whiteboard sheet information 114. Contents of the display changes will be described later.

The storage unit 11 stores the sheet management program 110, which causes the controller 10 to operate as the units 100 to 106; the terminal information 111, which identifies each of the electronic whiteboard 2 and the information terminals 3a to 3c; the sheet information 112, which is information regarding virtual sheets; the sticky note information 113, which is information regarding virtual sticky notes; the electronic whiteboard sheet information 114, which is information defining the states of sheets that are displayed (or hidden) in the electronic whiteboard 2; and the information terminal sheet information 115, which is information regarding the sheets that are being displayed in the information terminals 3a to 3c and the sheets to which sticky notes are to be sent.

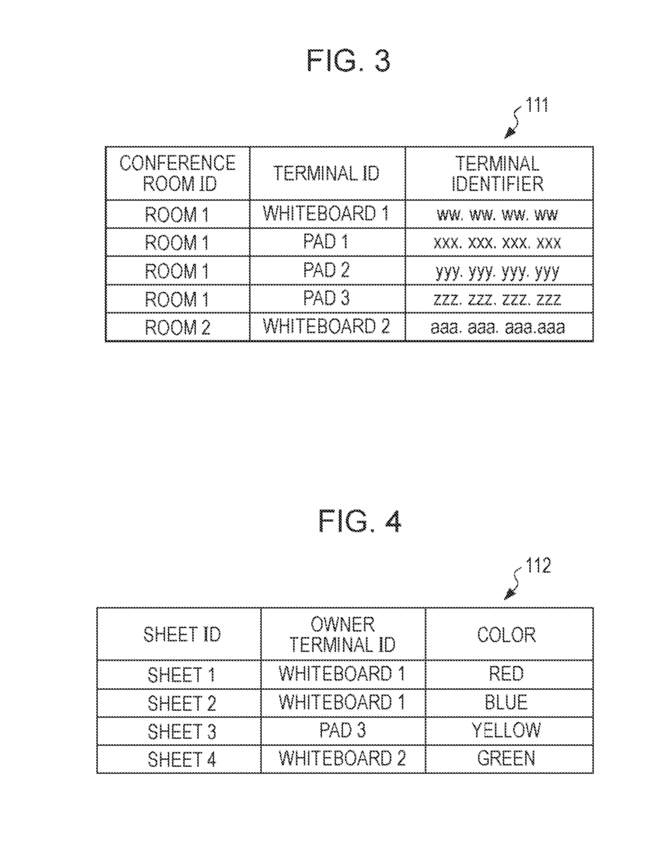

FIG. 3 is a schematic view illustrating an example of the structure of the terminal information 111.

The terminal information 111 is information regarding terminals, such as the electronic whiteboard 2 and the information terminals 3a to 3c. The terminal information 111 includes the conference room ID field that contains the ID of the conference room where the terminal is placed, the terminal ID field that contains the ID of the terminal, and the terminal identifier field that contains the IP address or the like.

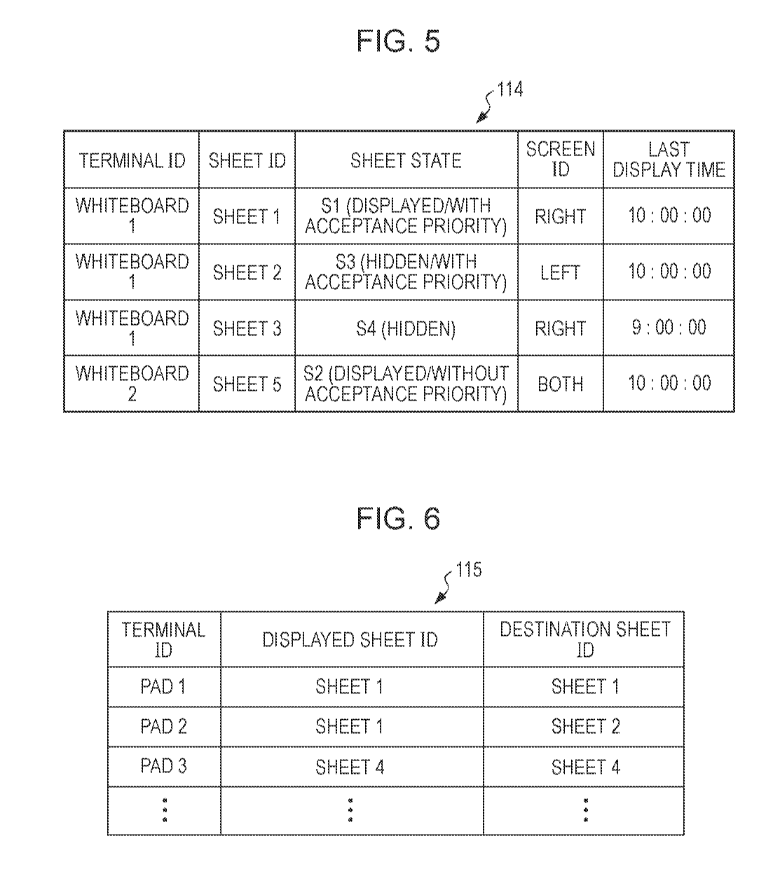

FIG. 4 is a schematic view illustrating an example of the structure of the sheet information 112.

The sheet information 112 is information regarding virtual sheets. The sheet information 112 includes the sheet ID field that contains the ID of the sheet, the owner terminal ID field that specifies the terminal that has created the sheet, and the color field that specifies the color of the sheet. As described later, the color of sheet is used as the color of the frame of the sheet. The color of the frame of the sheet corresponds to a second display attribute.

As long as the use of the same color for simultaneously used sheets is avoided, the color in the color field may be selected by the user or in accordance with a predetermined condition when the sheet is created.

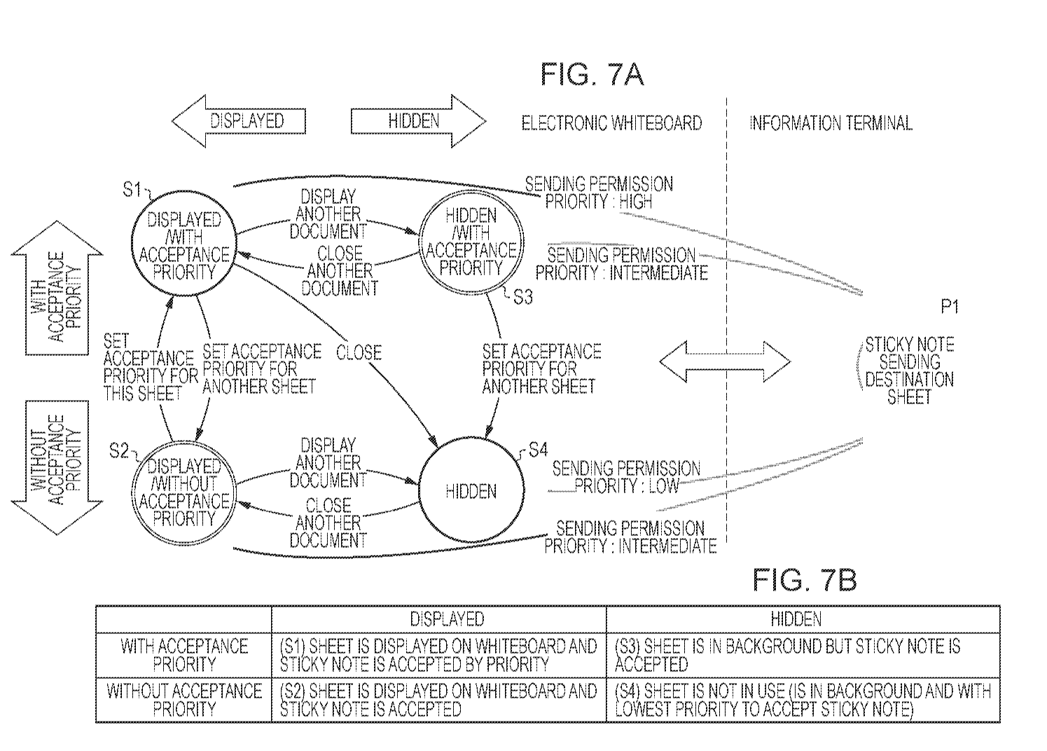

FIG. 5 is a schematic view illustrating an example of the structure of the electronic whiteboard sheet information 114.

The electronic whiteboard sheet information 114 is information regarding sheets displayed in the electronic whiteboard 2. The electronic whiteboard sheet information 114 includes the terminal ID field, which contains the ID of the electronic whiteboard 2; the sheet ID field, which contains the ID of the sheet that is being displayed or hidden in the electronic whiteboard 2; the sheet state field, which specifies the state of the sheet described later; the screen ID field, which contains the ID of the screen of the electronic whiteboard 2 where the sheet is displayed; and the last display time field, which specifies the time at which the sheet was displayed last.

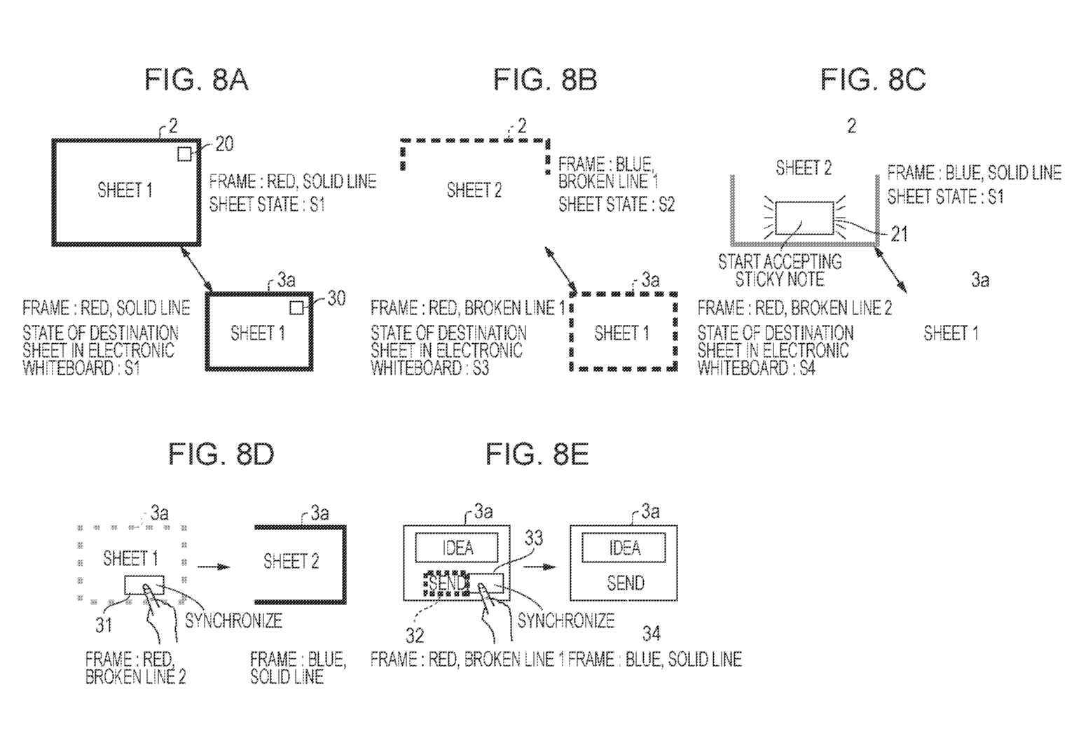

FIG. 6 is a schematic view illustrating an example of the structure of the information terminal sheet information 115.

The information terminal sheet information 115 is information regarding sheets displayed in the information terminals 3a to 3c. The information terminal sheet information 115 includes the terminal ID field, which contains the IDs of the information terminals 3a to 3c; the displayed sheet ID field, which contains the IDs of the sheets that are being displayed in the individual information terminals 3a to 3c; and the destination sheet ID field, which contains the IDs of the sheets to which (with which) sticky notes created by the individual information terminals 3a to 3c are to be sent (associated).

Operations of Sheet Management Server

Referring to FIGS. 1 to 13, the operation of the sheet management server 1 will be described below. The description is divided into three sections:

1) Operation of electronic whiteboard,
2) Operation of information terminal, and
3) Specific examples of display operations of electronic whiteboard and information terminal.

### 1) Operation of Electronic Whiteboard

A description will be given of examples of the state of the sheet in the electronic whiteboard 2, which have been described with reference to FIG. 5.

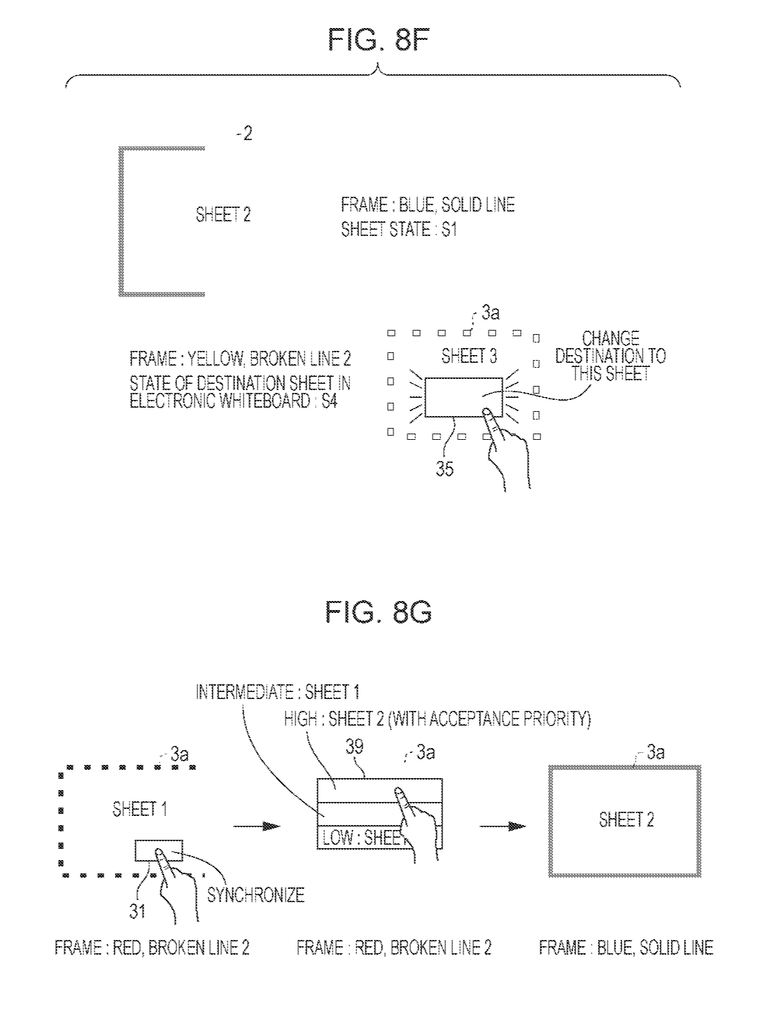

FIGS. 7A and 7B are state diagrams for explaining an example of the operation of the sheet management server 1.

As illustrated in FIG. 7A, a sheet displayed in the electronic whiteboard 2 may be in any one of states S1 to S4. Based on the relationship between the states S1 to S4 and a state P1, in which the destination sheet of each of the information terminals 3a to 3c is set, it is determined whether or not sticky notes created in the information terminal can be sent (attached) to the sheet.

Examples of the state of the sheet include a “with acceptance priority” state and a “without acceptance priority” state. The “with acceptance priority” state indicates that a sticky note for the sheet in this state is accepted with priority. The “without acceptance priority” state indicates that a sticky note for the sheet in this state is accepted with a lower priority than that of the “with acceptance priority” state. For example, sheet information of a sheet that is mainly discussed is set as sheet information “with acceptance priority” by the conference moderator (facilitator, for example, user 4d) as the conference progresses.

Examples of the state of the sheet also include a “displayed” state in which the sheet is being displayed, and a “hidden” state in which the sheet is not displayed. The overall state of the sheet is expressed as a combination of these states and those mentioned above. The sheet in the state S1 is being displayed and given acceptance priority (“S1 (displayed/with acceptance priority)”). The sheet in the state S2 is being displayed but is not given acceptance priority (“S2 (displayed/without acceptance priority)”). The sheet in the state S3 is hidden but is given acceptance priority (“S3 (hidden/with acceptance priority)”). The sheet in the state S4 is hidden (“S4 (hidden)”). The “displayed” state includes a case where multiple sheets are displayed on one screen of the electronic whiteboard 2 and a case where the electronic whiteboard 2 has multiple screens, which are displaying multiple sheets.

The state changes between S1 to S4 in the following manner.

The state of the sheet changes from S1 to S2 once the user performs the operation for changing the state of another sheet from the “without acceptance priority” state to “with acceptance priority” state. The state of the sheet changes from S2 to S1 once the user performs the operation for setting the sheet to be in “S1 (displayed/with acceptance priority)”.

The state of the sheet changes from S1 to S3 once the user performs the operation for displaying another document or the like on the sheet. The state of the sheet changes from S3 to S1 once the user performs the operation for closing another document displayed on the sheet.

The state of the sheet changes from S1 to S4 once the user performs the operation for closing the sheet.

The state of the sheet changes from S3 to S4 once the user performs the operation for changing the state of another sheet from the “without acceptance priority” state to the “with acceptance priority” state.

The state of the sheet changes from S2 to S4 once the user performs the operation for displaying another document on the sheet without acceptance priority. The state of the sheet changes from S4 to S2 once the user performs the operation for closing another document displayed on the sheet without acceptance priority.

As illustrated in FIG. 7B, whether or not sending (attaching) a sticky note to a sheet is permitted changes depending on the above-described states S1 to S4. In the state S1, the sheet is displayed in the electronic whiteboard 2 and sticky notes sent thereto from the information terminals 3a to 3c are accepted with priority. In the state S2, the sheet is also displayed in the electronic whiteboard 2 but is “without acceptance priority”. Thus, sticky notes sent thereto from the information terminals 3a to 3c are accepted with a lower priority.

In the state S3, the sheet is not being displayed in the electronic whiteboard 2 but is “with acceptance priority”. Thus, sticky notes sent thereto from the information terminals 3a to 3c are accepted with priority. In the state S4, the sheet is not being displayed in the electronic whiteboard 2 and is given the lowest priority to accept sticky notes sent thereto from the information terminals 3a to 3c out of the states S1 to S4.

The operation of the electronic whiteboard 2 will be described on the basis of the above-described states S1 to S4.

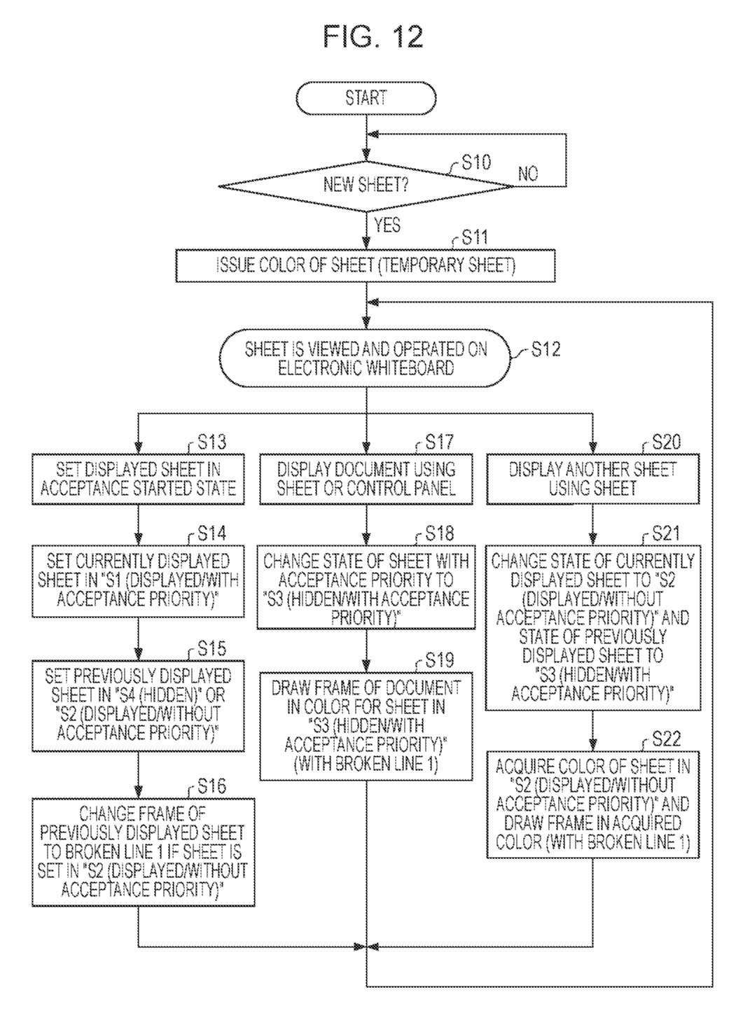

FIG. 12 is a flowchart for explaining examples of the operations of the sheet management server 1 and the electronic whiteboard 2.

When a new sheet is used (S10), the sheet information display unit 101 of the sheet management server 1 registers this new sheet to the sheet information 112 and issues the color of the sheet (S11) before various operations are performed on the sheet displayed in the electronic whiteboard 2 (S12). At this time, the new sheet is treated as the temporary sheet, and “S2 (displayed/without acceptance priority)” is set in the sheet state field.

Then, various operations are performed in the electronic whiteboard 2 (S12).

If the user performs, as an example of the operation, the operation for setting the displayed sheet in a state in which acceptance is started (S13), the electronic whiteboard sheet information updating unit 104 updates the sheet state field of the electronic whiteboard sheet information 114 for the currently displayed sheet to “S1 (displayed/with acceptance priority)”. Also, the sheet is displayed together with a first decoration (for example, together with a solid-line frame) (S14). Subsequently, the electronic whiteboard sheet information updating unit 104 updates the sheet state field for the sheet that had been set in “S1 (displayed/with acceptance priority)” before the update, to “S4 (hidden)” or “S2 (displayed/without acceptance priority)” (S15). If the electronic whiteboard 2 has multiple displays, the number of displays may be set as the upper limit of the number of sheets set in “S1 (displayed/with acceptance priority)” and “S2 (displayed/without acceptance priority)”. If the number of sheets set in S1 and S2 exceeds the upper limit, the state of a sheet selected in accordance with a predetermined condition is updated to “S3 (hidden/with acceptance priority)” or “S4 (hidden)”.

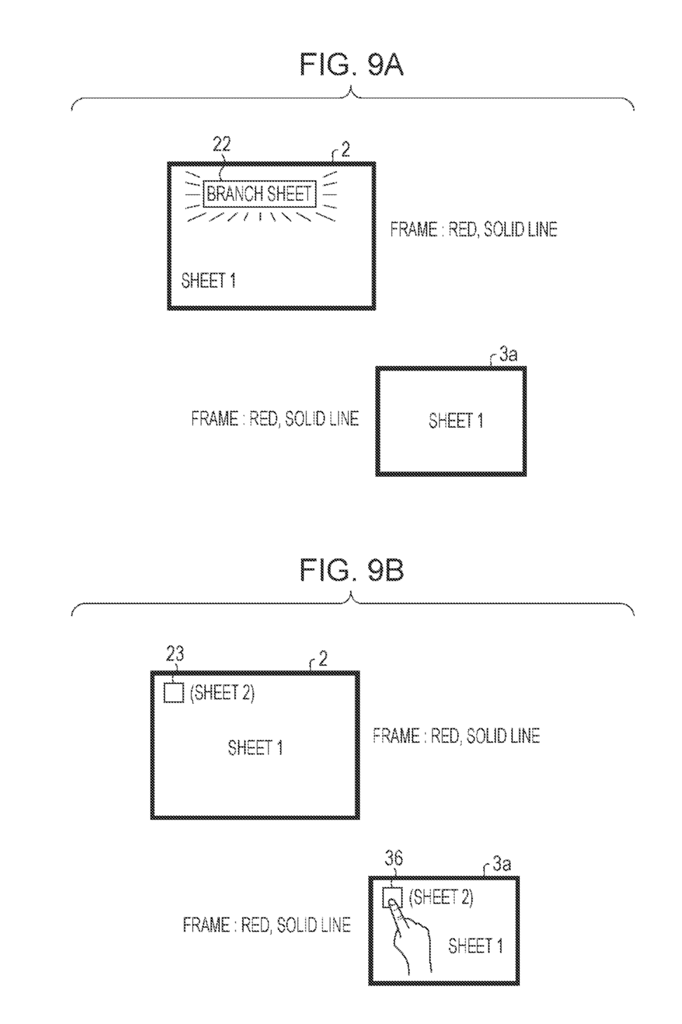

If there is a sheet whose sheet state is updated from “S1 (displayed/with acceptance priority)” to “S2 (displayed/without acceptance priority)”, the display control unit 106 changes the decoration of the sheet from the first decoration to a second decoration (S16). The second decoration has an emphasis level different from that of the first decoration. For example, when a first display attribute is the line type and the first decoration is a solid line, the second decoration is a broken line (broken line 1), which has an emphasis level lower than that of the solid line (see FIGS. 8A to 10C). As described above, the second display attribute is the color of the frame, and is decided by the content of the color field of the sheet information 112.

As another example of the operation, if the user operates an icon on the displayed sheet or operates the control panel to open and display document information (S17), the electronic whiteboard sheet information updating unit 104 updates the sheet state field of the electronic whiteboard sheet information 114 for the sheet that is no longer displayed as a result of displaying the document information, from “S1 (displayed/with acceptance priority)” to “S3 (hidden/with acceptance priority)” (S18).

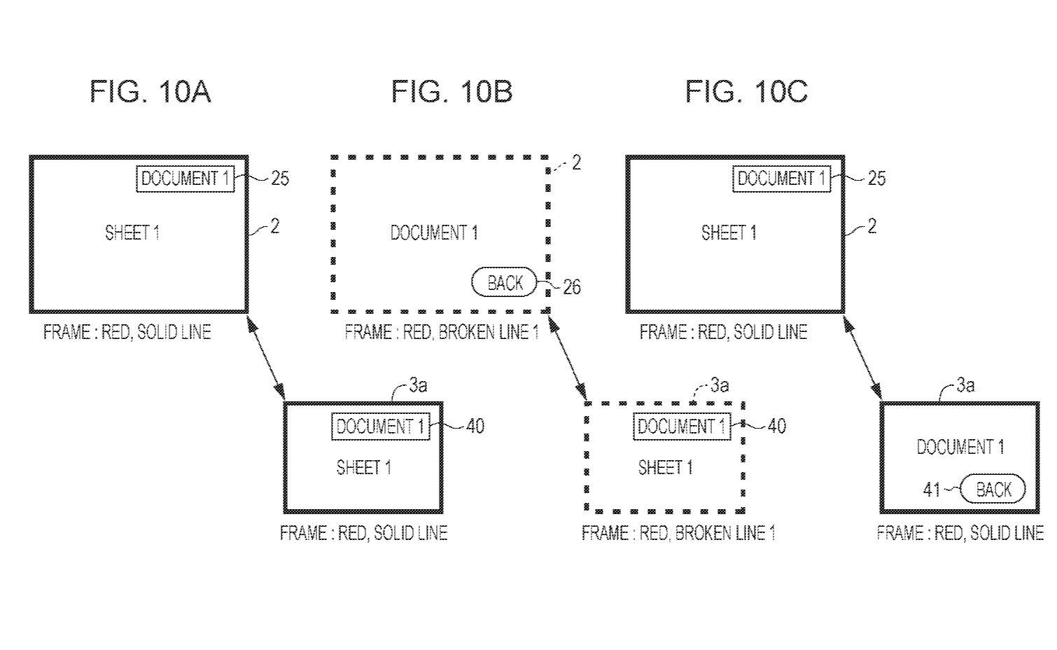

The display control unit 106 acquires, from the sheet information 112, the color of the sheet set in “S3 (hidden/with acceptance priority)”, and re-draws the frame of the displayed document information by using the broken line 1 in the acquired color (S19) (see FIG. 10B).

As still another example of the operation, if the user operates an icon on the displayed sheet to display another sheet (S20), the electronic whiteboard sheet information updating unit 104 updates the sheet state of the other sheet currently displayed to “S2 (displayed/without acceptance priority)”. The electronic whiteboard sheet information updating unit 104 also updates the sheet state field of the sheet that had been in “S1 (displayed/with acceptance priority)” to “S3 (hidden/with acceptance priority)”.

At this time, the display control unit 106 acquires the color of the sheet set in the sheet state “S2 (displayed/without acceptance priority)”, and re-draws the frame thereof by using the broken line 1 in the acquired color (S22) (see FIG. 8B).

### 2) Operation of Information Terminal

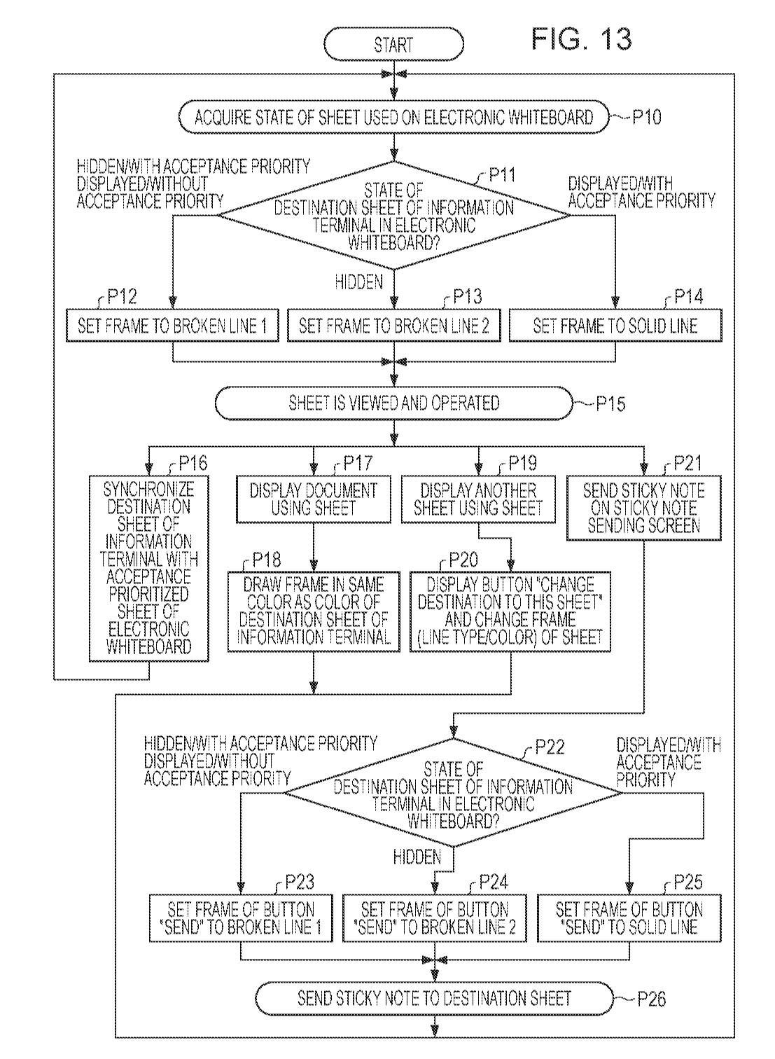

FIG. 13 is a flowchart for explaining examples of the operations of the sheet management server 1 and the information terminals 3a to 3c.

The terminal information acquisition unit 100 first refers to the electronic whiteboard sheet information 114 to acquire the state of one or more sheets that are used in the electronic whiteboard 2 placed in the same conference room as the information terminals 3a to 3c (P10).

The display control unit 106 then refers to the information terminal sheet information 115 of the specific information terminal, e.g., the information terminal 3a, to obtain the “sheet 1” set in the destination sheet ID field. The display control unit 106 then refers to the state of the “sheet 1” in the electronic whiteboard 2 (P11).

If the sheet state field indicates “S1 (displayed/with acceptance priority)” in step P11, the display control unit 106 displays the first decoration together with the sheet in the information terminal 3a (P14) (see FIG. 8A).

If the sheet state field indicates “S3 (hidden/with acceptance priority)” or “S2 (displayed/without acceptance priority)” in step P11, the display control unit 106 displays the second decoration together with the sheet in the information terminal 3a (P12) (see FIG. 8B).

If the sheet state field indicates “S4 (hidden)” in step P11, the display control unit 106 displays a third decoration together with the sheet in the information terminal 3a. The difference between the emphasis levels of the first and third decorations is greater than the difference between the emphasis levels of the first and second decorations. For example, when a frame of the solid line and a frame of the broken line 1 are used as the first and second decorations, respectively, a frame of a broken line 2, which is sparser than the broken line 1, may be used as the third decoration (P13) (see FIG. 8C).

If the users view and operate the sheets in the individual information terminals 3a to 3c, the sheet management server 1 accepts the content of the operations via the network 5 (P15).

An example of the operations performed on the sheets in the information terminals 3a to 3c is the operation for synchronizing the destination sheets of the information terminals 3a to 3c with the sheet that is given acceptance priority in the electronic whiteboard 2. If the user performs this synchronization operation, the information terminal sheet information updating unit 105 synchronizes the sheet set in the destination sheet ID field of the information terminal sheet information 115 with the sheet having “S1 (displayed/with acceptance priority)” or “S3 (hidden/with acceptance priority)” in the sheet state field of the electronic whiteboard sheet information 114 (P16) (see FIG. 8D). Thereafter, steps P10 to P14 are repeated again, and consequently the frame, which has been displayed with the broken line 1 or 2, is displayed with the solid line.

If, as another example of the operation performed on the sheet, the user operates an icon on the displayed sheet to open and display document information (P17), the display control unit 106 refers to the destination sheet ID field of the information terminal sheet information 115 to identify the sheet, and re-draws the frame of the displayed document information by using the broken line 1 in the color of the sheet (P18) (see FIG. 10C).

If, as still another example of the operation performed on the sheet, the user operates an icon on the displayed sheet to display another sheet (P19), the destination sheet of this information terminal may be changed to this sheet. Specifically, the operation image display unit 103 displays a “CHANGE DESTINATION TO THIS SHEET” button. If the user operates this button, the information terminal sheet information updating unit 105 updates the destination sheet ID field of the information terminal sheet information 115 to the currently displayed sheet. Additionally, the display control unit 106 changes the frame of the destination sheet displayed in the information terminals 3a to 3c. At this time, the line type is decided in accordance with the state of the destination sheet in the electronic whiteboard 2 and the color of the frame is modified to the color of the sheet (P20) (see FIG. 8F).

If, as yet another example of the operation performed on the sheet, the user creates a sticky note in each of the information terminals 3a to 3c, and switches the screen to a sticky note sending screen (P21), the display control unit 106 refers to the information terminal sheet information 115 of the specific information terminal, i.e., the information terminal 3a, to identify the “sheet 1” set in the destination sheet ID field. The display control unit 106 then refers to the sheet state field for this sheet in the electronic whiteboard 2 (P22).

If the sheet state field indicates “S3 (hidden/with acceptance priority)” or “S2 (displayed/without acceptance priority)” in step P22, the display control unit 106 displays the frame of a “SEND” button by using the broken line 1 (displays the second decoration) in the information terminal 3a (P23) (see FIG. 8E).

If the sheet state field indicates “S4 (hidden)” in step P22, the display control unit 106 displays the frame of the “SEND” button by using the broken line 2, which is different from the broken line 1, (displays the third decoration) in the information terminal 3a (P24).

If the sheet state field indicates “S1 (displayed/with acceptance frequency)” in step P22, the display control unit 106 displays the frame of the “SEND” button by using the solid line (displays the first decoration) in the information terminal 3a (P25).

If the user then operates the “SEND” button, which is displayed as a result of one of the steps P23 to P25, to confirm sending, the sticky note is sent to the destination sheet (P26).

### 3) Specific Examples of Display Operations of Electronic Whiteboard and Information Terminal

A description will be given below of specific display examples of the electronic whiteboard 2 and the information terminals 3a to 3c in accordance with the above-described operations of the electronic whiteboard 2 and the information terminals 3a to 3c.

FIGS. 8A to 8G are schematic views for explaining examples of the operation of the sheet management server 1.

When the sheet state field for the “sheet 1” displayed in the electronic whiteboard 2 is “S1 (displayed/with acceptance priority”) as in the electronic whiteboard sheet information 114 illustrated in FIG. 5, the display control unit 106 displays the frame of the “sheet 1” by using the “solid line” (displays the first decoration) in “red”, which is the color of the “sheet 1”, as illustrated in FIG. 8A.

The destination sheet ID field of the information terminal sheet information 115 specifies the “sheet 1”, the state of which in the electronic whiteboard 2 is “S1 (displayed/with acceptance priority)”. Thus, the display control unit 106 displays the frame of the “sheet 1” by using the “solid line” (displays the first decoration) in “red”, which is the color of the “sheet 1”, in the information terminal 3a.

Suppose that the displayed sheet is switched to the “sheet 2” as illustrated in FIG. 8B through an icon 20 displayed in the electronic whiteboard 2 illustrated in FIG. 8A. If the sheet state field for the “sheet 2” displayed in the electronic whiteboard 2 specifies “S2 (displayed/without acceptance priority)”, the display control unit 106 displays the frame of the “sheet 2” by using the “broken line 1” (displays the second decoration) in “blue”, which is the color of the “sheet 2”.

The destination sheet ID field of the information terminal sheet information 115 specifies the “sheet 1”, the state of which in the electronic whiteboard 2 is “S3 (hidden/without acceptance priority)”. Thus, the display control unit 106 displays the frame of the “sheet 1” by using the “broken line 1” (displays the second decoration) in “red”, which is the color of the “sheet 1”, in the information terminal 3a.

If the user operates a “START ACCEPTING STICKY NOTE” button 21 on the “sheet 2” displayed in the electronic whiteboard 2 as illustrated in FIG. 8C, the sheet state field for the “sheet 2” changes from “S2 (displayed/without acceptance priority)” to “S1 (displayed/with acceptance priority)”. In this case, the display control unit 106 displays the frame of the “sheet 2” by using the “solid line” (displays the first decoration) in “blue”, which is the color of the “sheet 2”.

The destination sheet ID field of the information terminal sheet information 115 specifies the “sheet 1”, the state of which in the electronic whiteboard 2 is “S4 (hidden)”. Thus, the display control unit 106 displays the frame of the “sheet 1” by using the “broken line 2”, which is sparser than the “broken line 1”, (displays the third decoration) in “red”, which is the color of the “sheet 1”, in the information terminal 3a.

Now, the user pushes a “SYNCHRONIZE” button 31 displayed in the information terminal 3a as illustrated in FIG. 8D. Then, the information terminal sheet information updating unit 105 synchronizes the destination sheet ID field of the information terminal sheet information 115 with the sheet having “S1 (displayed/with acceptance priority)” in the sheet state field of the electronic whiteboard sheet information 114. The display control unit 106 switches the sheet displayed in the information terminal 3a to the “sheet 2”, which is the sheet that is being displayed in the electronic whiteboard 2, and also displays the frame thereof by using the “solid line” (displays the first decoration) in “blue”, which is the color of the “sheet 2”.

On the sticky note sending screen displayed in the information terminal 3a, the color of the frame of the “SEND” button is set to the color of the destination sheet to which the sticky note is to be sent and the line type thereof is set in accordance with the state of the destination sheet in the electronic whiteboard 2 as illustrated in FIG. 8E. For example, suppose that the destination sheet ID field of the information terminal sheet information 115 specifies the “sheet 1” and the sheet state field of the electronic whiteboard sheet information 114 for the “sheet 1” specifies “S2 (displayed/without acceptance priority)”. In this case, the display control unit 106 displays the frame of the “SEND” button 21 by using the “broken line 1” in the color of the “sheet 1”. The sticky note sending screen also displays a “SYNCHRONIZE” button 33. If the user pushes the “SYNCHRONIZE” button 33, the destination sheet ID field of the information terminal sheet information 115 is synchronized with the sheet having “S1 (displayed/with acceptance priority)” in the sheet state field of the electronic whiteboard sheet information 114. Consequently, the frame of the “SEND” button 34 is displayed using the “solid line” (the first decoration is displayed) in “blue”, which is the color of the “sheet 2”, in the information terminal 3a.

If the user pushes the “CHANGE DESTINATION TO THIS SHEET” button 35 with the “sheet 3” being displayed in the information terminal 3a as illustrated in FIG. 8F, the information terminal sheet information updating unit 105 may synchronize the sheet specified in the destination sheet ID field of the information terminal sheet information 115 with the sheet displayed in the information terminal 3a.

If the user pushes the “SYNCHRONIZE” button 31 displayed in the information terminal 3a as illustrated in FIG. 8G, the display control unit 106 displays a history 39 regarding sheets having been displayed in the electronic whiteboard 2. The sheet displayed in the information terminal 3a is also synchronized with the sheet selected from the history 39. Additionally, the information terminal sheet information updating unit 105 synchronizes the destination sheet ID field of the information terminal sheet information 115 with the selected sheet. Consequently, the display control unit 106 displays the frame of the “sheet 2” with the solid line (displays the first decoration) in “blue”, which is the color of the “sheet 2”, in the information terminal 3a.

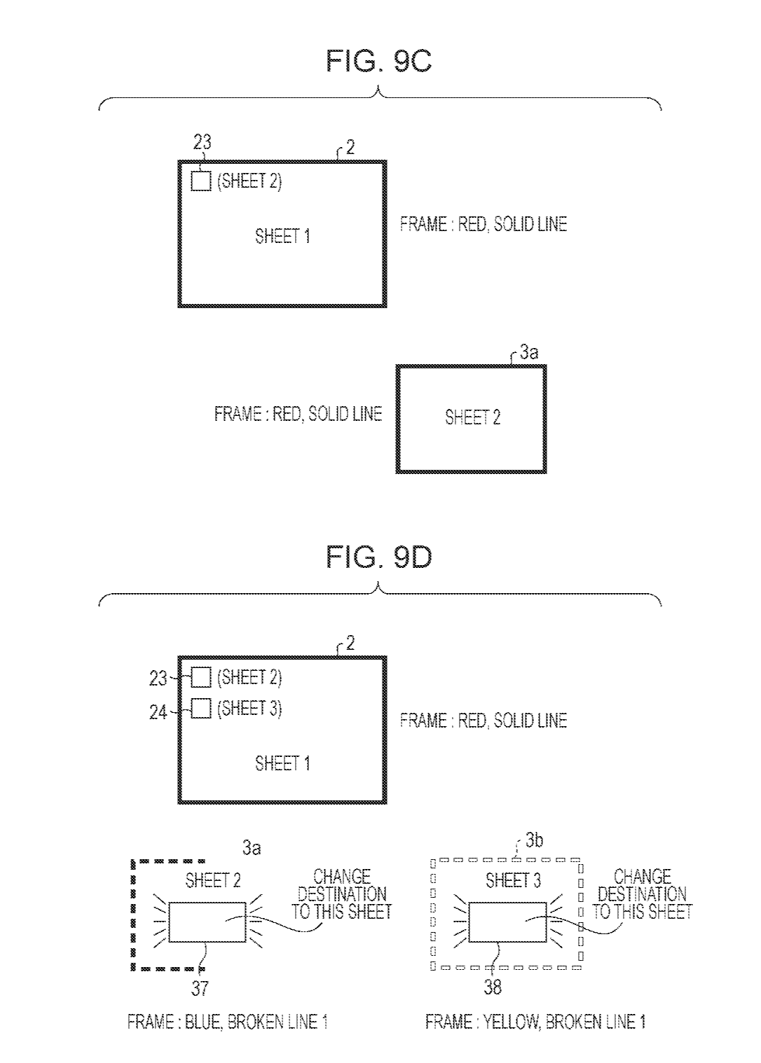

FIGS. 9A to 9D are schematic views for explaining examples of the operation of the sheet management server 1.

If the user operates a “BRANCH SHEET” button 22 with the “sheet 1” being displayed in the electronic whiteboard 2 as illustrated in FIG. 9A, an icon 23 for the “sheet 2” is created on the “sheet 1” as illustrated in FIG. 9B.

As illustrated in FIG. 9B, an icon 36 for the “sheet 2” is also created on the “sheet 1” in the information terminal 3a. If the user selects the “SHEET 2” icon 36 in the information terminal 3a to switch the screen, the “sheet 2” is displayed in the information terminal 3a as illustrated in FIG. 9C.

As illustrated in FIG. 9D, an icon 24 for the “sheet 3” is further created on the “sheet 1” displayed in the electronic whiteboard 2 as a result of the similar operation described above. If the user selects a “SHEET 3” icon (not illustrated) in the information terminal 3b, the display control unit 106 displays the “sheet 3” in the information terminal 3b.

Suppose that the users push the “CHANGE DESTINATION TO THIS SHEET” buttons 37 and 38 with the “sheet 2” and the “sheet 3” being displayed in the information terminals 3a and 3b, respectively. In this case, the information terminal sheet information updating unit 105 synchronizes the sheet set in the destination sheet ID field of the information terminal sheet information 115 associated with the information terminals 3a and 3b with the sheets displayed in the information terminals 3a and 3b, respectively.

FIGS. 10A to 10C are schematic view for explaining examples of the operation of the sheet management server 1.

As illustrated in FIG. 10A, an icon 25 for a “document 1” may be created with the “sheet 1” being displayed in the electronic board 2 and placed on the “sheet 1”. If the user selects the “DOCUMENT 1” icon 25 to open the “document 1” in the electronic whiteboard 2, the “document 1” is displayed on the “sheet 1” in the electronic whiteboard 2 as illustrated in FIG. 10B. At this time, the display control unit 106 displays the frame of the “document 1” by using the broken line 1 (displays the second decoration) in “red”, which is the color for the “sheet 1”, so as to indicate that the “document 1” is displayed just temporarily. A “BACK” button 26 is also shown on the displayed “document 1”. The user may return the screen to the “sheet 1” illustrated in FIG. 10A by operating the “BACK” button 26.

The “sheet 1” displayed in the information terminal 3a is in the sheet state “S3 (hidden/with acceptance priority)” in the electronic whiteboard 2. Thus, the display control unit 106 displays the frame by using the “broken line 1”.

As illustrated in FIG. 10A, an icon 40 for the “document 1” may be created with the “sheet 1” being displayed in the information terminal 3a and placed on the “sheet 1”. If the user selects the “DOCUMENT 1” icon 40 to open the “document 1” in the information terminal 3a, the “document 1” is displayed on the “sheet 1” in the information terminal 3a as illustrated in FIG. 10C. Since the “sheet 1” is in the state “S1 (displayed/with acceptance priority)” in the electronic whiteboard 2, the frame of the “document 1” is displayed using the “solid line” (the first decoration) in “red”, which is the color for the “sheet 1”. A “BACK” button 41 is also shown on the displayed “document 1”. The user may return the screen to the “sheet 1” illustrated in FIG. 10A by operating the “back” button 41.

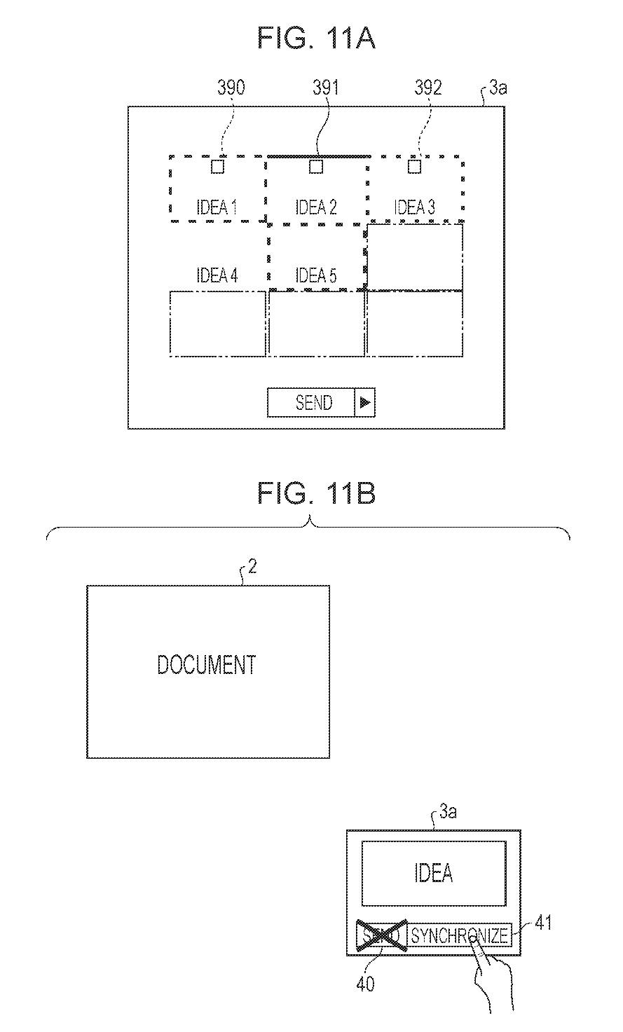

FIGS. 11A and 11B are schematic views for explaining examples of the operation of the sheet management server 1.

As illustrated in FIG. 11A, it is possible to accumulate sticky notes 390, 391, 392, etc., which have been created in the information terminal 3a and on which ideas are written, without sending the sticky notes. The display control unit 106 displays the sticky notes 390, 391, 392, etc., in the same colors as the colors of the destination sheets that were set at the time when the individual sticky notes were created. Based on the relationship between the sheet that is currently given “acceptance priority” and the sheet displayed in the electronic whiteboard 2, the frame of each sticky note is displayed using the “solid line” (first decoration), the “broken line 1” (second decoration), or the “broken line 2” (third decoration).

If the sheet that was once set as the destination sheet in the information terminal 3a no longer exists, the display control unit 106 displays, as illustrated in FIG. 11B, the cross-out “SEND” button 40 in the color of the destination sheet on the sticky note sending screen so as to inform the user that sending is not selectable. As in the case illustrated in FIG. 8E, the user may synchronize the destination sheet with the sheet given “acceptance priority” by operating the “SYNCHRONIZE” button 41.

### Other Exemplary Embodiments

The present invention should not be limited to the exemplary embodiment described above and may be modified variously within the scope that does not depart from the spirit of the present invention. One or more components, such as the terminal information acquisition unit 100, the sheet information display unit 101, the sticky note information display unit 102, the operation image display unit 103, and the display control unit 106, which function in the controller 10 of the sheet management server 1 may be configured to function in the electronic whiteboard 2 and the information terminals 3a to 3c.

Also, the sheet management program 110 may be stored on a storage medium, such as a compact disc-read only memory (CD-ROM), and provided, or may be downloaded to a storage unit of an apparatus from a server connected to a network, such as the Internet. Additionally, one or more components, such as the terminal information acquisition device 100, the sheet information display unit 101, the sticky note information display unit 102, the operation image display unit 103, and the display control unit 106, may be implemented using hardware, such as an application specific integrated circuit (ASIC). The order in which the operation steps described in the above exemplary embodiment are executed may be changed, some of the operation steps may be omitted, and new operation steps may be added.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A non-transitory computer readable medium storing a program causing a computer to execute a process for virtual-sheet management, the process comprising:
storing in a memory
a plurality of pieces of sticky note information used to display a plurality of virtual sticky notes in a first apparatus and a second apparatus, the first apparatus including a display viewed by a plurality of users, the second apparatus including a display smaller than the display of the first apparatus,
a plurality of pieces of sheet information each of which is used to display a virtual sheet as the background of a plurality of virtual sticky notes in the first apparatus and the second apparatus, and each of which is to be associated with a plurality of pieces of sticky note information corresponding to the plurality of virtual sticky notes displayed on the virtual sheet,
first apparatus sheet information that specifies priority sheet information which is selected, as sheet information that is given priority, in the first apparatus from among the plurality of pieces of sheet information, and
second apparatus sheet information that specifies target sheet information which is selected, as sheet information with which sticky note information is to be associated, in the second apparatus from among the plurality of pieces of sheet information;
displaying
on the display of the first apparatus, a virtual sheet of sheet information that is selected in the first apparatus from among the plurality of pieces of sheet information stored in the memory and that is to be associated with a plurality of pieces of sticky note information, and
on the display of the second apparatus, a virtual sheet of sheet information that is selected in the second apparatus from among the plurality of pieces of sheet information stored in the memory and that is to be associated with a plurality of pieces of sticky note information;
updating
upon the priority sheet information being selected in the first apparatus, the first apparatus sheet information in accordance with the selected priority sheet information, and
upon the target sheet information being selected in the second apparatus, the second apparatus sheet information in accordance with the selected target sheet information; and
performing control
if the sheet information of the virtual sheet that is being displayed in the first apparatus is selected as the priority sheet information specified by the first apparatus sheet information and association of sticky note information with the sheet information is to be accepted, so as to display a first decoration together with the virtual sheet of the sheet information in the first apparatus,
if the sheet information of the virtual sheet that is being displayed in the first apparatus is not selected as the priority sheet information specified by the first apparatus sheet information but association of sticky note information with the sheet information is to be accepted, so as to display a second decoration together with the virtual sheet of the sheet information in the first apparatus, the second decoration being different from the first decoration,
if the target sheet information specified by the second apparatus sheet information is selected as the priority sheet information and is of the virtual sheet that is being displayed in the first apparatus, so as to display the first decoration together with the virtual sheet of the target sheet information in the second apparatus,
if the target sheet information specified by the second apparatus sheet information is not selected as the priority sheet information but is of the virtual sheet that is being displayed in the first apparatus or if the target sheet information specified by the second apparatus sheet information is selected as the priority sheet information but is not of the virtual sheet that is being displayed in the first apparatus, so as to display the second decoration together with the virtual sheet of the target sheet information in the second apparatus, the second decoration being different from the first decoration, and
if the target sheet information specified by the second apparatus sheet information is not selected as the priority sheet information and is not of the virtual sheet that is being displayed in the first apparatus, so as to display a third decoration together with the virtual sheet of the target sheet information in the second apparatus, the third decoration being different from the first decoration and the second decoration.

2. The non-transitory computer readable medium according to claim 1,
wherein the performing control further includes displaying,
if the target sheet information specified by the second apparatus sheet information is selected as the priority sheet information and is of the virtual sheet that is being displayed in the first apparatus, an image for operating the target sheet information together with the first decoration in the second apparatus, and
if the target sheet information specified by the second apparatus sheet information is not selected as the priority sheet information but is of the virtual sheet that is being displayed in the first apparatus or if the target sheet information specified by the second apparatus sheet information is selected as the priority sheet information but is not of the virtual sheet that is being displayed in the first apparatus, an image for operating the target sheet information together with the second decoration in the second apparatus.

3. The non-transitory computer readable medium according to claim 2,
wherein the performing control further includes
displaying, if the target sheet information specified by the second apparatus sheet information is not selected as the priority sheet information and is not of the virtual sheet that is being displayed in the first apparatus, an image for operating the target sheet information together with the third decoration in the second apparatus.

4. A virtual-sheet management apparatus comprising:
a memory that stores
a plurality of pieces of sticky note information used to display a plurality of virtual sticky notes in a first apparatus and a second apparatus, the first apparatus including a display viewed by a plurality of users, the second apparatus including a display smaller than the display of the first apparatus,
a plurality of pieces of sheet information each of which is used to display a virtual sheet as the background of a plurality of virtual sticky notes in the first apparatus and the second apparatus, and each of which is to be associated with a plurality of pieces of sticky note information corresponding to the plurality of virtual sticky notes displayed on the virtual sheet,
first apparatus sheet information that specifies priority sheet information which is selected, as sheet information that is given priority, in the first apparatus from among the plurality of pieces of sheet information, and
second apparatus sheet information that specifies target sheet information which is selected, as sheet information with which sticky note information is to be associated, in the second apparatus from among the plurality of pieces of sheet information;
a sheet information display unit that displays
on the display of the first apparatus, a virtual sheet of sheet information that is selected in the first apparatus from among the plurality of pieces of sheet information stored in the memory and that is to be associated with a plurality of pieces of sticky note information, and
on the display of the second apparatus, a virtual sheet of sheet information that is selected in the second apparatus from among the plurality of pieces of sheet information stored in the memory and that is to be associated with a plurality of pieces of sticky note information;
an updating unit that updates
upon the priority sheet information being selected in the first apparatus, the first apparatus sheet information in accordance with the selected priority sheet information, and
upon the target sheet information being selected in the second apparatus, the second apparatus sheet information in accordance with the selected target sheet information; and
a display control unit that performs control
if the sheet information of the virtual sheet that is being displayed in the first apparatus by the sheet information display unit is selected as the priority sheet information specified by the first apparatus sheet information and association of sticky note information with the sheet information is to be accepted, so as to display a first decoration together with the virtual sheet of the sheet information in the first apparatus,
if the sheet information of the virtual sheet that is being displayed in the first apparatus by the sheet information display unit is not selected as the priority sheet information specified by the first apparatus sheet information but association of sticky note information with the sheet information is to be accepted, so as to display a second decoration together with the virtual sheet of the sheet information in the first apparatus, the second decoration being different from the first decoration,
if the target sheet information specified by the second apparatus sheet information is selected as the priority sheet information and is of the virtual sheet that is being displayed in the first apparatus, so as to display the first decoration together with the virtual sheet of the target sheet information in the second apparatus,
if the target sheet information specified by the second apparatus sheet information is not selected as the priority sheet information but is of the virtual sheet that is being displayed in the first apparatus or if the target sheet information specified by the second apparatus sheet information is selected as the priority sheet information but is not of the virtual sheet that is being displayed in the first apparatus, so as to display the second decoration together with the virtual sheet of the target sheet information in the second apparatus, the second decoration being different from the first decoration, and
if the target sheet information specified by the second apparatus sheet information is not selected as the priority sheet information and is not of the virtual sheet that is being displayed in the first apparatus, so as to display a third decoration together with the virtual sheet of the target sheet information in the second apparatus, the third decoration being different from the first decoration and the second decoration.

5. A virtual-sheet management method comprising:
storing in a memory
a plurality of pieces of sticky note information used to display a plurality of virtual sticky notes in a first apparatus and a second apparatus, the first apparatus including a display viewed by a plurality of users, the second apparatus including a display smaller than the display of the first apparatus,
a plurality of pieces of sheet information each of which is used to display a virtual sheet as the background of a plurality of virtual sticky notes in the first apparatus and the second apparatus, and each of which is to be associated with a plurality of pieces of sticky note information corresponding to the plurality of virtual sticky notes displayed on the virtual sheet,
first apparatus sheet information that specifies priority sheet information which is selected, as sheet information that is given priority, in the first apparatus from among the plurality of pieces of sheet information, and
second apparatus sheet information that specifies target sheet information which is selected, as sheet information with which sticky note information is to be associated, in the second apparatus from among the plurality of pieces of sheet information;
displaying
on the display of the first apparatus, a virtual sheet of sheet information that is selected in the first apparatus from among the plurality of pieces of sheet information stored in the memory and that is to be associated with a plurality of pieces of sticky note information, and
on the display of the second apparatus, a virtual sheet of sheet information that is selected in the second apparatus from among the plurality of pieces of sheet information stored in the memory and that is to be associated with a plurality of pieces of sticky note information;
updating
upon the priority sheet information being selected in the first apparatus, the first apparatus sheet information in accordance with the selected priority sheet information, and
upon the target sheet information being selected in the second apparatus, the second apparatus sheet information in accordance with the selected target sheet information; and
performing control
if the sheet information of the virtual sheet that is being displayed in the first apparatus is selected as the priority sheet information specified by the first apparatus sheet information and association of sticky note information with the sheet information is to be accepted, so as to display a first decoration together with the virtual sheet of the sheet information in the first apparatus,
if the sheet information of the virtual sheet that is being displayed in the first apparatus is not selected as the priority sheet information specified by the first apparatus sheet information but association of sticky note information with the sheet information is to be accepted, so as to display a second decoration together with the virtual sheet of the sheet information in the first apparatus, the second decoration being different from first decoration,
if the target sheet information specified by the second apparatus sheet information is selected as the priority sheet information and is of the virtual sheet that is being displayed in the first apparatus, so as to display the first decoration together with the virtual sheet of the target sheet information in the second apparatus,
if the target sheet information specified by the second apparatus sheet information is not selected as the priority sheet information but is of the virtual sheet that is being displayed in the first apparatus or if the target sheet information specified by the second apparatus sheet information is selected as the priority sheet information but is not of the virtual sheet that is being displayed in the first apparatus, so as to display the second decoration together with the virtual sheet of the target sheet information in the second apparatus, the second decoration being different from the first decoration, and
if the target sheet information specified by the second apparatus sheet information is not selected as the priority sheet information and is not of the virtual sheet that is being displayed in the first apparatus, so as to display a third decoration together with the virtual sheet of the target sheet information in the second apparatus, the third decoration being different from the first decoration and the second decoration.
